(19) United States
(12) Patent Application Publication
(10) Pub. No.: US 2014/0304478 A1
(43) Pub. Date: Oct. 9, 2014

(54) Space Reclamation of Objects in a Persistent Cache

(71) Applicant: NEC Laboratories America, Inc., Princeton, NJ (US)

(72) Inventors: Cristian Ungureanu, Princeton, NJ (US); Stephen Rago, Warren, NJ (US); Akshat Aranya, Jersey City, NJ (US)

(73) Assignee: NEC Laboratories America, Inc., Princeton, NJ (US)

(21) Appl. No.: 14/247,201

(22) Filed: Apr. 7, 2014

Related U.S. Application Data
(60) Provisional application No. 61/808,948, filed on Apr. 5, 2013.

(51) Int. Cl. G06F 12/02; G06F 12/12; G06F 12/08

(52) U.S. Cl. CPC G06F 12/0253; G06F 12/0891; G06F 12/123; G06F 2212/702
USPC 711/135

(57) ABSTRACT

Disclosed herein are methods and structures for a computer cache that includes its own garbage collection component that reclaims space occupied by free objects in the cache such that the cache avoids retaining deleted objects thereby increasing cache hit ratios and further permits short-lived dirty objects to be deleted without requiring them to be written back to an underlying store.

### CROSS REFERENCE TO RELATED APPLICATIONS

This application claims the benefit of U.S. Provisional Patent Application Ser. No. 61/808,948 filed Apr. 5, 2013 which is incorporated by reference in its entirety as if set forth at length herein.

### TECHNICAL FIELD

This disclosure relates generally to the field of computers and information systems and in particular to methods and structures pertaining to the reclamation of storage space such as found with a persistent cache.

### BACKGROUND

Contemporary computer and information systems make extensive use of cache storage structures. As is known, cache must be managed such that portions of it are allocated to processes and/or programs at their request and freed for reuse when no longer needed. A form of management known as “garbage collection” attempts to reclaim cache memory occupied by objects that are no longer in use by the program. Given its importance to contemporary computer systems, improved garbage collection methods for cache systems would represent a welcome addition to the art.

### SUMMARY

An advance in the art is made according to an aspect of the present disclosure directed to garbage collection in a persistent cache. Viewed from a first aspect, the present disclosure provides method(s) for managing the cache such that any applications utilizing the cache do not have to manage the particularities of cache garbage collection.

Operationally, the cache management/garbage collection method includes: tracking trees of objects in a live space, said trees in live space including one or more objects and a root object; tracking trees of objects in an orphan space, said trees in orphan space including one or more objects and no root object; moving any trees of objects in the live space to a new live space if those trees of objects do not include a root object that has been marked for deletion; reclaiming the space of any trees of objects having a root object marked for deletion.

Trees of objects according to the present disclosure are constructed from the bottom-up in the orphan space until a root object is associated with those objects. Advantageously, garbage collection is performed by the cache method, and therefore allows any short-lived objects to be released from the cache, without requiring them to be written through to an underlying store. Additionally, methods according to the present disclosure allow applications to use and subsequently delete trees of objects stored in a cache without having to delete all constituent objects in the tree when the tree of objects is no longer needed by the application.

### BRIEF DESCRIPTION OF THE DRAWING

A more complete understanding of the present disclosure may be realized by reference to the accompanying drawings in which:

FIG. 1 shows in schematic form two trees of objects in a cache according to an aspect of the present disclosure;

FIG. 2 shows a flowchart depicting a WriteObject operation according to an aspect of the present disclosure;

FIG. 3 shows a flowchart depicting a DeleteRoot operation according according to an aspect of the present disclosure;

FIG. 4 shows a flowchart depicting a ReclaimObjects operation according to an aspect of the present disclosure; and

FIG. 5 shows a schematic block diagram of an illustrative computer system on which aspects of the present disclosure may be operated and/or executed.

### DETAILED DESCRIPTION

The following merely illustrates the principles of the disclosure. It will thus be appreciated that those skilled in the art will be able to devise various arrangements which, although not explicitly described or shown herein, embody the principles of the disclosure and are included within its spirit and scope. More particularly, while numerous specific details are set forth, it is understood that embodiments of the disclosure may be practiced without these specific details and in other instances, well-known circuits, structures and techniques have not been shown in order not to obscure the understanding of this disclosure.

Furthermore, all examples and conditional language recited herein are principally intended expressly to be only for pedagogical purposes to aid the reader in understanding the principles of the disclosure and the concepts contributed by the inventor(s) to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently-known equivalents as well as equivalents developed in the future, i.e., any elements developed that perform the same function, regardless of structure.

Thus, for example, it will be appreciated by those skilled in the art that the diagrams herein represent conceptual views of illustrative structures embodying the principles of the invention.

In addition, it will be appreciated by those skilled in art that any flow charts, flow diagrams, state transition diagrams, pseudocode, and the like represent various processes which may be substantially represented in computer readable medium and so executed by a computer or processor, whether or not such computer or processor is explicitly shown.

In the claims hereof any element expressed as a means for performing a specified function is intended to encompass any way of performing that function including, for example, a) a combination of circuit elements which performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. Applicant thus regards any means which can provide those functionalities as equivalent as those shown herein. Finally, and unless otherwise explicitly specified herein, the drawings are not drawn to scale.

Thus, for example, it will be appreciated by those skilled in the art that the diagrams herein represent conceptual views of illustrative structures embodying the principles of the disclosure.

By way of some additional background, it is noted that contemporary computer and information systems include memory and/or storage management systems that oftentimes utilize persistent caching mechanisms and structures to facilitate reading/writing from/to those memory and/or storage systems. The utility of such persistent caching mechanisms is well documented and understood.

As application programs execute on these computer systems they acquire portions of the cache and release it for reuse when no longer needed. More particularly—and by way of example only—application programs generally acquire portions of the cache to hold objects used during the execution of the programs. When the application terminates or the objects are no longer needed, the application releases those portions of the cache used to hold the objects. To insure that the requested/released cache is actually available for reuse, a form of cache management known as garbage collection attempts to reclaim cache memory occupied by objects that are no longer in use by the program.

Typically, a traditional garbage collection system and associated cache management strategy relies on being able to identify “live” and “dead” objects in the cache. More particularly, the garbage collection system ignores live objects (those objects still in use by the application), and frees the cache space used by all dead objects thereby making that space available in the cache for other application(s)/objects.

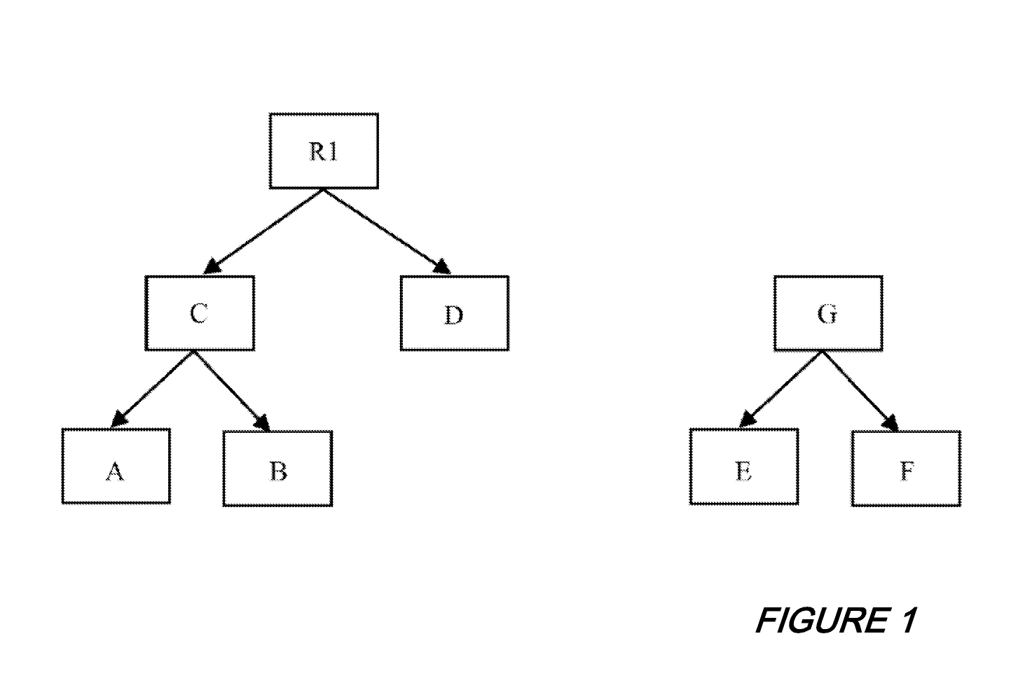

Turning now to FIG. 1, there is shown in schematic form two trees of objects stored in a persistent cache according to an aspect of the present disclosure. The cache is persistent in that objects written to the cache persist in the cache and do not necessarily get immediately written back or written through to an underlying storage system. This advantageously allows the persistent cache to maintain its currency even during off-line periods.

With continued reference to FIG. 1, it is noted that the persistent cache includes multiple objects that are stored as “trees”. More precisely, the objects are stored as directed acyclic graphs, or acyclic digraphs or “DAG”s, however we use the term tree because it is easier to visualize and trees are a subclass of DAGs.

As depicted in that FIG. 1, the tree on the left has a root (R1) and includes objects A, B, C, and D. Conversely, the tree on the right—comprising objects E, F, and G has no root.

Briefly, trees listed in a Live Space comprise objects that are considered “live” in that they may still be used by an application and have not been marked for deletion. Trees of objects listed in an Orphan List—as we shall see—are those under construction and as may be readily appreciated the storage space they occupy in the cache may not be reclaimed.

Operationally, an application marks or “tags” the root of trees that are to be deleted. Garbage collection according to the present disclosure tracks object trees in the Live Space combined with the Orphan List to determine what space may be reclaimed.

More specifically, the Orphan List maintains the list of child objects that are not yet reachable by a root (i.e., right tree in FIG. 1). As non-root objects are added to the cache, they are added to and tracked in the Orphan List.

When a root is added, any objects in that root's tree are moved from the orphan list to the Live Space and the root is added to a list of roots in the Live Space. When a tree is to be deleted, its root is tagged for deletion and the root is removed from the list of roots in the Live Space.

When the set of dead objects—those whose space may be reclaimed—is to be determined, we start with the live roots and copy all object trees they reference to a NewLive Space. Objects in the Orphan List are left alone—as they represent objects not yet part of any tree. As a result, objects remaining in the Live Space (Old Live Space) contains a list of all dead objects whose space in the cache may be reclaimed.

As may now be appreciated, while persistent cache systems and methods according to the present disclosure provide and support other operations, three in particular are of specific interest. More particularly:
WriteObject: writes an object to the cache. A flag distinguishes root objects from other objects. A list of child objects specifies which other objects, if any, this written object points to; and
DeleteRoot: marks a root object as able to be deleted. This does not actually delete the object; and
ReclaimObjects: reclaim the space occupied by all dead objects.

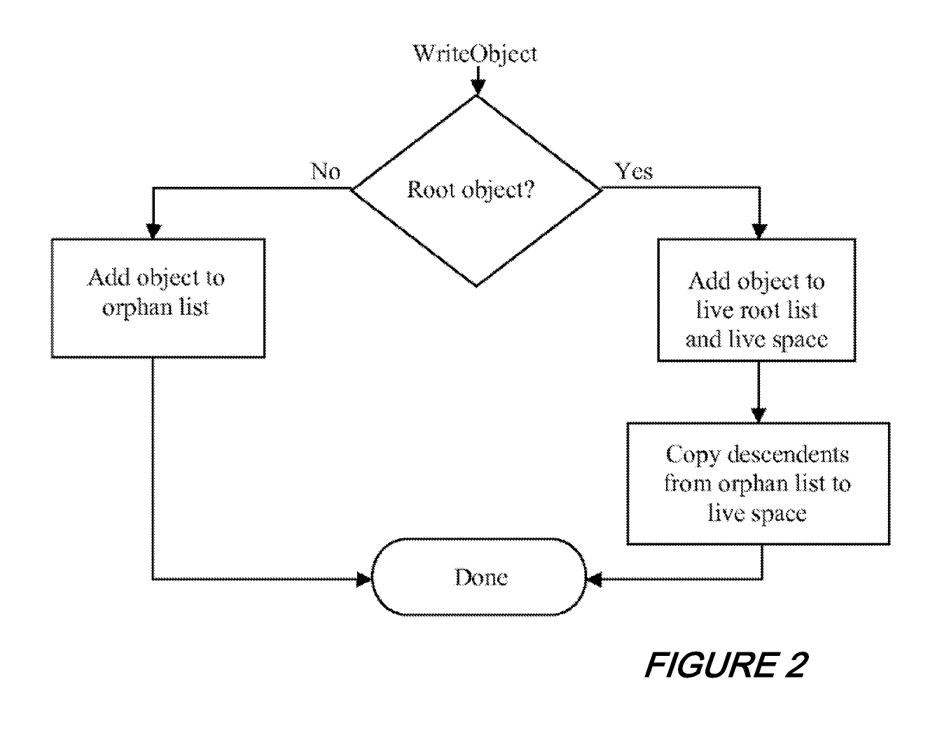

Turning now to FIG. 2, there it shows a flow chart for the WriteObject operation. As shown therein upon entry to WriteObject a determination is made whether or not the object to be written is a root object. If it is not, then the object is added to the Orphan List and the operation ends. Conversely, if the object to be written is determined to be a root object, then that root object is added to the Live Root List and Live Space and descendents are copied from the Orphan List to the Live Space.

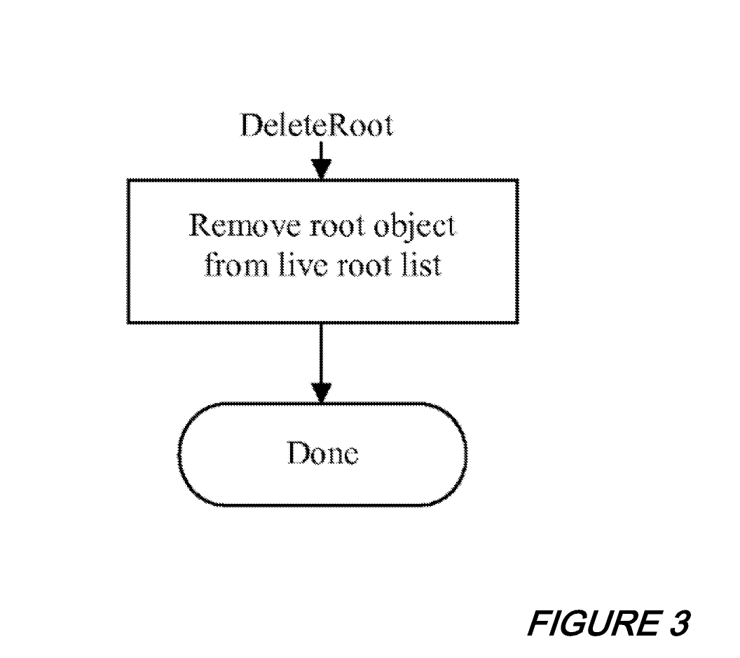

FIG. 3 shows a flow chart depicting the DeleteRoot operation. As shown there, upon entry to DeleteRoot the root object is removed from the live root list. As may be appreciated, when the DeleteRoot operation is performed the root is marked for deletion such that any cache space occupied by the tree of objects reference by the deleted root is now reclaimable.

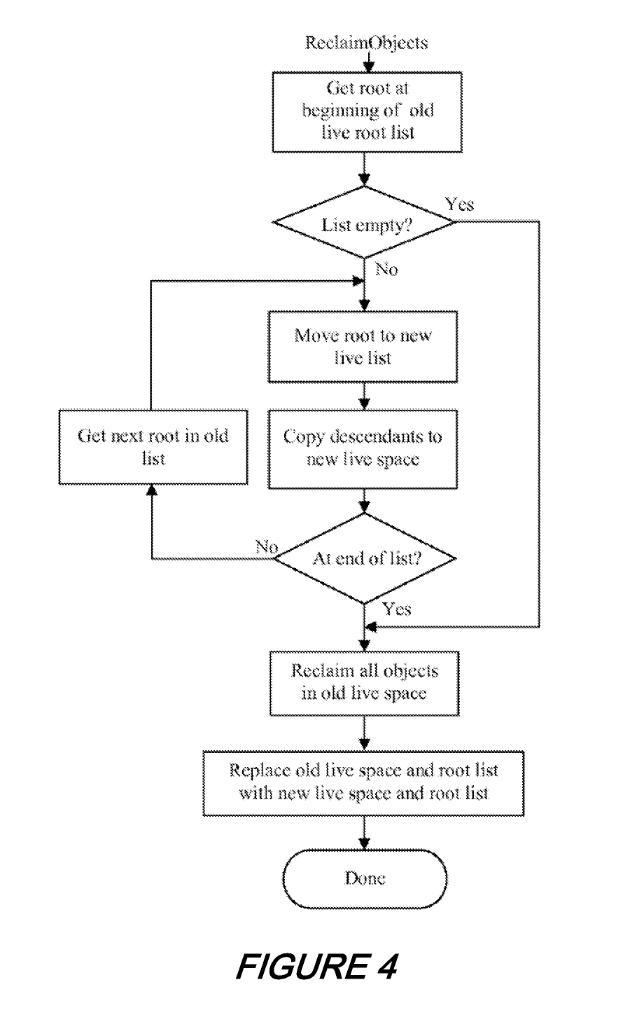

FIG. 4 shows a flow chart depicting the ReclaimObjects operation according to an aspect of the present disclosure. More specifically, upon entry ReclaimObjects first obtains a root at the beginning of an old, live root list. If the list is not empty, then that root is moved to the list of roots in NewLive Space and any descendants referenced by that root are copied to the NewLive Space. That process continues with the next root in the old list until all (live) roots in the old list are moved and the end of the old list is reached.

Next, all objects remaining in the old live space are reclaimed (the storage they occupy in the cache is reclaimed) and the old live space and root list is replaced with the new live space and root list. Because objects in the Orphan List are not present in the live space, the orphan objects are not reclaimed.

As may be appreciated, with these three operations, applications (the user of the cache) provides information to the cache about which roots are no longer needed and can therefore be considered dead such that any space in the cache they occupy may be reclaimed. Objects that don't yet have a root (under construction) are hidden from the garbage collection operation such that their space is not reclaimed.

Advantageously, the persistent cache garbage collection method and structures according to the present disclosure is a hybrid one, wherein applications construct object trees in the cache while inserting objects in a bottom-up manner, and then tag or otherwise mark the roots of the object trees. When a tree of objects needs to be deleted, the application aids the garbage collection method by tagging the roots of trees that can be reclaimed. Accordingly, the garbage collection method then handles the detection of objects that may be deleted while avoiding any intermediate objects.

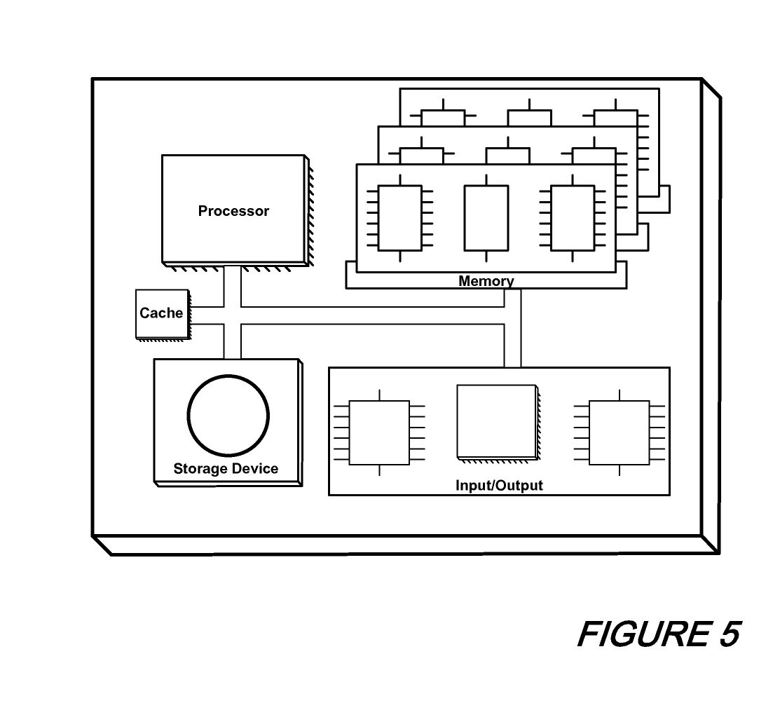

FIG. 5 shows in schematic form an exemplary computer system in which the methods and structures disclosed may be operated. Such exemplary computer includes at least a processor, memory and input/output components which may include cache and programs and systems that perform the operations disclosed.

Those skilled in the art will readily appreciate that while the methods, techniques and structures according to the present disclosure have been described with respect to particular implementations and/or embodiments, those skilled in the art will recognize that the disclosure is not so limited. Accordingly, the scope of the disclosure should only be limited by the claims appended hereto.

1. In a computer system comprising a processor, memory and input/output structures, said computer system providing an execution platform for one or more application programs, said computer system providing a cache for the application programs to store objects used by the applications during execution, said objects being classified as belonging to a LiveList, a NewLiveList or an OrphanList, a caching method comprising the steps of:
marking, by the application program(s), a root of a tree of objects in the LiveList that is to be deleted;
copying, any tree of objects not marked for deletion to the NewLiveList;
releasing from the cache, any space occupied by the objects represented by the trees remaining in the LiveList.
wherein said objects include an object identifier, the object's contents, and a list of any children of the object.

2. The method of claim 1 further comprising the steps of:
by the application, adding new objects to the cache including for each object an identifier, the object contents, a list of any child objects, and an indication of whether the object is a root object

3. The method of claim 2 further comprising the steps of:
by the application, determining whether an object to be written to the cache is a root object, and if so, adding the root object to the LiveList and copying any descendents from the OrphanList to the LiveList, otherwise adding the object to the OrphanList.

4. A computer implemented method of space reclamation of objects in a cache comprising:
tracking trees of objects in a live space, said trees in live space including one or more objects and one or more root objects;
tracking trees of objects in an orphan space, said trees in orphan space including one or more objects and no root object;
moving any trees of objects in the live space to a new live space if those trees of objects do not include a root object that has been marked for deletion;
reclaiming the space of any trees of objects having a root object marked for deletion.
